(19) United States
(12) Patent Application Publication
(10) Pub. No.: US 2024/0240796 A1
(43) Pub. Date: Jul. 18, 2024

(54) DEPLOYABLE APPARATUS AND GRILLING MODULE

(71) Applicant: Rivian IP Holdings, LLC, Plymouth, MI (US)

(72) Inventors: Lindsey Michelle Cross, Dana Point, CA (US); Austin Simpson, Huntington Beach, CA (US); Rex Martin, Los Angeles, CA (US); Parmita Dalal, Dana Point, CA (US)

(21) Appl. No.: 18/155,908

(22) Filed: Jan. 18, 2023

(51) Int. Cl. F24C 7/10; B60L 1/00; B60R 5/00

(52) U.S. Cl. CPC F24C 7/10; B60L 1/00; B60R 5/00

(57) ABSTRACT

A deployable apparatus and grilling module. The apparatus can include a grilling module. The grilling module can include a cooking surface. The cooking surface can be electrically coupled with a power source. The apparatus can include a shuttle. The grilling module can be coupled with the shuttle. The shuttle can stow the grilling module and the shuttle can deploy the grilling module.

### INTRODUCTION

Vehicles can have batteries and the batteries can provide power to components of the vehicle.

### SUMMARY

This disclosure is generally directed to a grilling module that can be stored, in a stowed position, within the gear tunnel of a vehicle. The grilling module can be electrically coupled with the electric vehicle. The grilling module can be deployed to a position that is outside of the gear tunnel which enables the grilling module to be utilized. For example, a user cannot turn on the grilling module prior to moving the grilling module to the position that is outside of the gear tunnel.

At least one aspect is directed to an apparatus. The apparatus can include a grilling module. The grilling module can include a cooking surface. The cooking surface can be electrically coupled with a power source. The grilling module can be coupled with a shuttle. The shuttle can stow the grilling module and the shuttle can deploy the grilling module.

At least one aspect is directed to an apparatus. The apparatus can include a grilling module. The grilling module can include a cooking surface. The cooking surface can be electrically coupled with a power source. The grilling module can include a housing. The housing can be coupled with the cooking surface. The apparatus can include a shuttle. The shuttle can be coupled with the housing. The shuttle can stow the grilling module in a first position. The shuttle can deploy the grilling module to a second position. The apparatus can include a locking mechanism. The locking mechanism can be coupled with the shuttle. The locking mechanism can hold the grilling module in at least one of the first position or the second position.

At least one aspect is directed to a method. The method can include providing an apparatus. The apparatus can include a grilling module. The grilling module can include a cooking surface. The cooking surface can be electrically coupled with a power source. The grilling module can be coupled with a shuttle. The method can include stowing the grilling module. The method can include deploying the grilling module.

At least one aspect is directed to a method. The method can include providing an apparatus. The apparatus can include a grilling module. The grilling module can include a cooking surface. The cooking surface can be electrically coupled with a power source. The grilling module can include a housing. The housing can be coupled with the cooking surface. The apparatus can include a shuttle. The shuttle can be coupled with the housing. The apparatus can include a locking mechanism. The locking mechanism can be coupled with the shuttle. The method can include stowing the grilling module in a first position. The method can include deploying the grilling module to a second position. The method can include holding the grilling module in at least one of the first position or the second position.

At least one aspect is directed to an electric vehicle. The electric vehicle can include a gear tunnel. The electric vehicle can include an apparatus. The apparatus can include a grilling module. The grilling module can include a cooking surface. The cooking surface can be electrically coupled with a battery. The grilling module can be coupled with a shuttle. The shuttle can stow the grilling module and the shuttle can deploy the grilling module.

At least one aspect is directed to an electric vehicle. The electric vehicle can include a gear tunnel. The electric vehicle can include an apparatus. The apparatus can include a grilling module. The grilling module can include a cooking surface. The cooking surface can be electrically coupled with a battery. The grilling module can include a housing. The housing can be coupled with the cooking surface. The apparatus can include a shuttle. The shuttle can be coupled with the housing. The shuttle can stow the grilling module in a first position. The first position can be within the gear tunnel. The shuttle can deploy the apparatus to a second position. The second position can be external to the gear tunnel. The apparatus can include a locking mechanism. The locking mechanism can be coupled with the shuttle. The locking mechanism can hold the grilling module in at least one of the first position or the second position.

At least one aspect is directed to a method. The method can include providing an apparatus. The apparatus can include a grilling module. The grilling module can include a cooking surface. The cooking surface can be electrically coupled with a power source. The grilling module can include a housing. The housing can be coupled with the cooking surface. The apparatus can include a shuttle. The shuttle can be coupled with the housing. The shuttle can stow the grilling module in a first position. The shuttle can deploy the grilling module to a second position. The apparatus can include a locking mechanism. The locking mechanism can be coupled with the shuttle. The locking mechanism can hold the grilling module in at least one of the first position or the second position.

At least one aspect is directed to a method of manufacturing an apparatus. The method can include coupling a grilling module with a shuttle. The grilling module can include a cooking surface. The cooking surface can be electrically coupled with a power source. The shuttle can stow the grilling module. The shuttle can deploy the grilling module.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle.

FIG. 2 depicts an example apparatus, in accordance with an implementation.

FIG. 3 depicts an example apparatus, in accordance with an implementation.

FIG. 4 depicts an example apparatus, in accordance with an implementation.

FIG. 5 depicts an example apparatus, in accordance with an implementation.

FIG. 6 depicts an example apparatus, in accordance with an implementation.

FIG. 7 depicts an example apparatus, in accordance with an implementation.

FIG. 8 depicts an example apparatus, in accordance with an implementation.

FIG. 9 depicts an example apparatus, in accordance with an implementation.

FIG. 10 depicts an example apparatus, in accordance with an implementation.

FIG. 11A depicts an example view of a vehicle, in accordance with an implementation.

FIG. 11B depicts an example apparatus, in accordance with an implementation.

FIG. 11C depicts an example apparatus, in accordance with an implementation.

FIG. 12 depicts an example apparatus, in accordance with an implementation.

FIG. 13 depicts an example apparatus, in accordance with an implementation.

FIG. 14 depicts an example system to control an apparatus, in accordance with an implementation.

FIG. 15 depicts an example flow diagram of a process to provide an apparatus, in accordance with an implementation.

FIG. 16 depicts an example flow diagram of a process to provide an apparatus, in accordance with an implementation.

FIG. 17 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of providing an apparatus. The various concepts introduced above and discussed in greater detail below may be implemented in any of numerous ways.

The present disclosure is directed to systems and methods of providing an apparatus. This technical solution can enable a user to stow and deploy the grilling module from a gear tunnel of a vehicle. Additionally, the grilling module can interface with the vehicle and the user to provide information associated with grilling module. For example, a user can be notified that the grilling module is not in a desired position. The grilling module can be electrically coupled with the electric vehicle in both a stored position (e.g., in the gear tunnel) or in a deployed position (e.g., outside the gear tunnel or external to the vehicle).

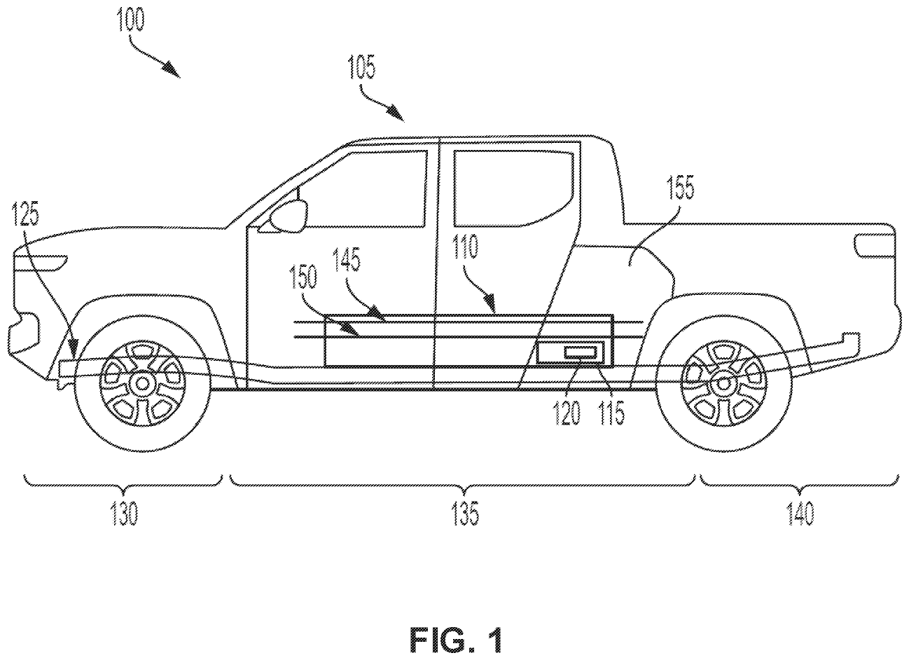

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

The electric vehicle 105 can include at least one gear tunnel door 155. A first gear tunnel door 155 can cover a first end of a gear tunnel. A second gear tunnel door 155 can cover a second end of the gear tunnel. The gear tunnel door 155 can move between open and closed positions sealing or exposing an interior of the gear tunnel. The gear tunnel door 155 can hinge on a bottom side, a top side, or a lateral side. The gear tunnel door 155 can be structured to support a shuttle. For example, the shuttle could extend out over the gear tunnel door 155 when the gear tunnel door 155 is in an open position. The shuttle can rest upon a surface of the gear tunnel door 155. The shuttle can extend out over the gear tunnel door 155 to provide access to components within the gear tunnel.

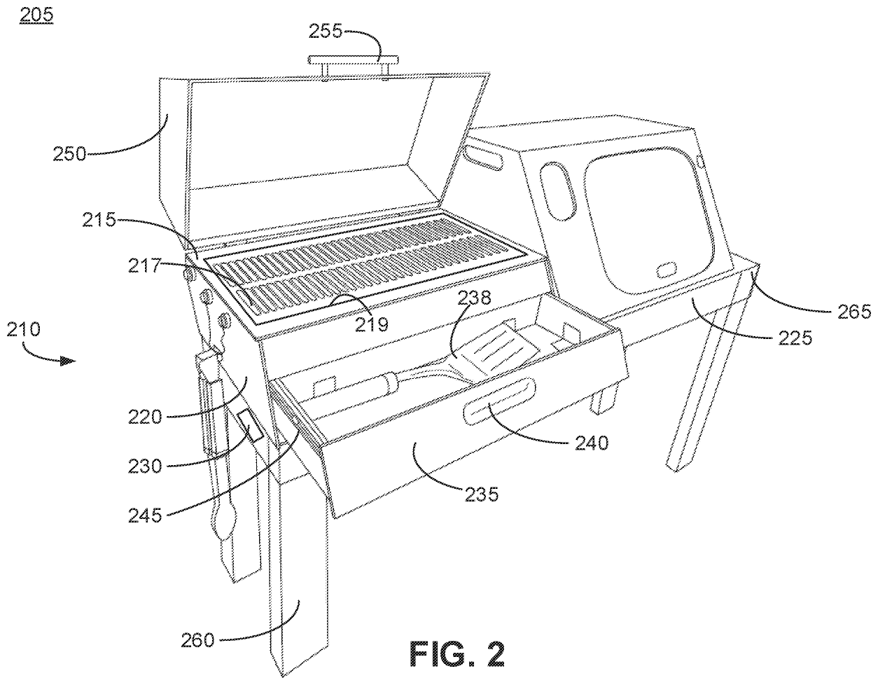

FIG. 2 depicts an example view of an apparatus 205. The apparatus 205 can be structured to fit within a gear tunnel of a vehicle. For example, the apparatus 205 can be structured to fit within the gear tunnel of the vehicle 105. The apparatus 205 can include at least one grilling module 210. The grilling module 210 can be at least one of a grill, a grilling apparatus or any other possible cooking apparatus. The grilling module 210 can include at least one cooking surface 215. The cooking surface 215 can be electrically coupled with a power source. The cooking surface 215 can receive power from the power source. For example, the power source can be the battery pack 110 and the cooking surface 215 can receive power from the battery pack 110. The grilling module 210 can include at least one housing 220. The cooking surface 215 can be mounted, attached, placed, secured or coupled with the housing 220. The cooking surface 215 can include at least one of an electric cooking surface, a coil cooking surface and a cast iron cooking surface. The cooking surface 215 can include at least one opening. The cooking surface 215 can include at least one grate 217. The grate 217 can include at least one of at least one marking, at least one imprint, at least one opening or at least one resistive coil.

The apparatus 205 can include at least one heating element 219. The heating element 219 can be mounted, attached, placed, secured or coupled with at least one of the cooking surface 215, the grate 217 or the housing 220. The heating element 219 can be located above, within or below at least one of the cooking surface 215, the grate 217 or the housing 220. The heating element 219 can provide heat to the cooking surface 215. The heating element 219 can be at least one of a metal resistive element or a ceramic heating element. The heating element 219 can include at least one of a knob, button, slide or meter that can be adjusted to adjust a setting or heat metric of the heating element. The heat metric can be a temperature value. For example, the heat metric can be set to 250 degrees Fahrenheit. An operator of the apparatus 205 can set the heat metric to a value. The heating element 219, responsive to the operator setting the heat metric, can heat the cooking surface 215 to a temperature that is at or around the operator set heat metric. The heating element 219 can heat the cooking surface 215 using at least one of induction heat, convection heat or radiant heat. The heating element 219 can be designed in at least one of a linear pattern that goes within, around or through the cooking surface 215, a zig-zag pattern that runs around or within the grates 217, a concentric pattern that runs around or through the cooking surface 215. FIG. 2 depicts an example of the heating element 219 in a linear pattern that goes around the cooking surface 215.

The apparatus 205 can include at least one shuttle 225. The shuttle 225 can be mounted, attached, placed, secured or coupled with the housing 220. The shuttle 225 can be structured to extend out over the gear tunnel door 155 when the gear tunnel door 155 is in an open position. The shuttle 225 can stow the grilling module 210. The grilling module 210 can be stowed in a position that is within a vehicle. The grilling module 210 can be stowed in a position that is within the gear tunnel of a vehicle. For example, the grilling module 210 can be stowed in a position that is within the gear tunnel of the vehicle 105. The shuttle 225 can deploy the grilling module 210. For example, FIG. 2 depicts an example of the grilling module 210 in a deployed position. The grilling module 210 can be deployed to a position that is external to a vehicle. The grilling module 210 can be deployed to a position that is external to the gear tunnel of a vehicle. For example, the grilling module 210 can be deployed to a position that is external to the gear tunnel of the vehicle 105. The grilling module 210 can have at least one stowed position and at least one deployed position. The grilling module 210 can have at least one fully deployed position (e.g., the entire grilling module 210 is external to the gear tunnel of the vehicle 105). The grilling module 210 can have at least one partial deployed position (e.g., a portion of the grilling module 210 is external the gear tunnel of the vehicle 105). The grilling module 210 can have at least one fully stowed position (e.g., the entire grilling module 210 is within the gear tunnel of the vehicle 105). The grilling module 210 can have a partial stowed position (e.g., a portion of grilling module 210 is within the gear tunnel of the vehicle 105). The power source can be coupled with the grilling module 210 when the grilling module is in a deployed position and a stowed position.

The apparatus 205 can include at least one locking mechanism 230. The locking mechanism 230 can be mounted, attached, placed, secured or coupled with the shuttle 225. The locking mechanism 230 can be used to hold the grilling module 210. For example, the locking mechanism 230 can hold the grilling module 210 in a stowed position or a deployed position. The locking mechanism 230 can hold the grilling module 210 by at least one of locking, keeping, securing or otherwise maintaining the position of the grilling module 210. For example, the locking mechanism 230 can lock the grilling module 210 in the first position. The locking mechanism 230 can include at least one of a latch, a switch, a lever, a slide, a clasp, a bolt, a bar, a clip or a lock. The locking mechanism 230 can have a closed position and an open position. For example, when the locking mechanism 230 is in the closed position the grilling module 210 can be held in the stowed or deployed position. When the locking mechanism 230 is in the open position the grilling module 210 can move. The grilling module 210 can move from a stowed position to a deployed position. The grilling module 210 can move from a deployed position to a stowed position. The grilling module 210 can move from a stowed position to a second stowed position. The grilling module 210 can move from a deployed position to a second deployed position.

The apparatus 205 can include at least one compartment 235. The compartment 235 can be mounted, attached, placed, secured or coupled with the housing 220. The compartment 235 can be at least one of a drawer, a cupboard or a tray. The compartment 235 can store at least one component 238. For example, the component 238 can be at least one of a cooking utensil (e.g., a spatula, a brush, a tong, a knife, a spoon or a fork), a container that holds spices (e.g., a salt and pepper shaker), a dish (e.g., a plate, a bowl or a cup) or a cutting board. The compartment 235 can have at least one handle 240. An operator of the apparatus 205 can use the handle 240 to open or close the compartment 235. The compartment 235 can have at least one position that is within the grilling module 210. The compartment 235 can have at least one position that is external to the grilling module 210. The compartment 235 can have at least one rail 245. The rail 245 can move the compartment 235 from a position that is within the grilling module 210 to a position that is external to the grilling module 210. The rail 245 can include at least one of a slide, a glider or a runner. For example, an operator can use the handle 240 to slide the compartment 235 from a position that is within the housing 220 to the position that is external the housing 220. An operator can use the handle 240 to slide the compartment 235 from a position that is external to the grilling module 210 to a second position that is external to the grilling module 210. The operator can retrieve the component 238 that can be stored in the compartment 235. FIG. 2 depicts an example of the compartment 235 in a position that is external to the grilling module 210.

The apparatus 205 can include at least one lid 250. The lid 250 can be mounted, attached, placed, secured or coupled with the cooking surface 215. The lid 250 can have an open and a closed position. For example, FIG. 2 depicts an example of the lid 250 in an open position. The open position can allow for an operator of the apparatus 205 to place or have access to at least one item (e.g., a piece of food) on the cooking surface 215. The closed position can cover the cooking surface 215. The closed position can insulate the cooking surface 215. The lid 250 can include at least one handle 255. An operator can use the handle 255 to move the lid 250 from a closed position to an open position. The operator can use the handle 255 to move the lid 250 from an open position to a closed position. The operator can use the handle 255 to move the lid 250 from a first open position to a second open position. The operator can use the handle 255 to move the lid 250 from a first closed position to a second closed position.

The apparatus 205 can include at least one leg 260. The leg 260 can be mounted, attached, placed, secured or coupled with the shuttle 225. The leg 260 can support the shuttle 225 when the shuttle 225 is in a position that is external to a gear tunnel of a vehicle. The leg 260 can have at least one length. The length of the 260 can be adjusted, extended, shortened or otherwise adapt. For example, the leg 260, by extending a distance that allows for the leg 260 to make contact with a surface (e.g., the ground), can support the shuttle 225. The leg 260 can support the shuttle 225 as the leg 260 can adjust the amount of weight that the shuttle 225 supports. The leg 260 can include a least one support position and at least one storage position. For example, FIG. 2 depicts an example of the leg 260 in a support position. The leg 260 can bend, fold or otherwise adjust to move from either the support position to the storage position or from the storage position to the support position. The leg 260 can move from a support position to a second support position. The leg 260 can move from a storage position to a second storage position. The leg 260 can be at a first height and a second leg 260 can be at a second height. For example, a first portion and a second portion of the shuttle 225 can be at different heights. The leg 260 that can support the first portion of the shuttle can extend to a height so that the leg 260 can make contact with a surface (e.g., the ground). The leg 260 that can support the second portion of the shuttle 225 can extend to a height sot that the leg 260 can make contact with the surface.

The apparatus 205 can include at least one rotation device 265. The rotation device 265 can be mounted, attached, placed, secured or coupled with the grilling module 210. The rotation device 265 can rotate the grilling module from a deployed position to a second deployed position. The rotation device 265 can rotate the grilling module 210 by at least 90 degrees. The rotation device 265 can provide additional space for the grilling module 210. For example, the grilling module 210 can be stowed within the gear tunnel of the vehicle 105. The grilling module 210 can be deployed to a position that is external the gear tunnel of the vehicle 105. The vehicle 105 can be positioned near an obstacle (e.g., another vehicle, a tree, a building) and the obstacle can encroach or can be very close to the grilling module 210. The grilling module 210 can be in the deployed position. The operator of the grilling module 210 can create more space between the grilling module 210 and the obstacle by using the rotation device 265 to rotate the grilling module 210 from the deployed position to a second deployed position.

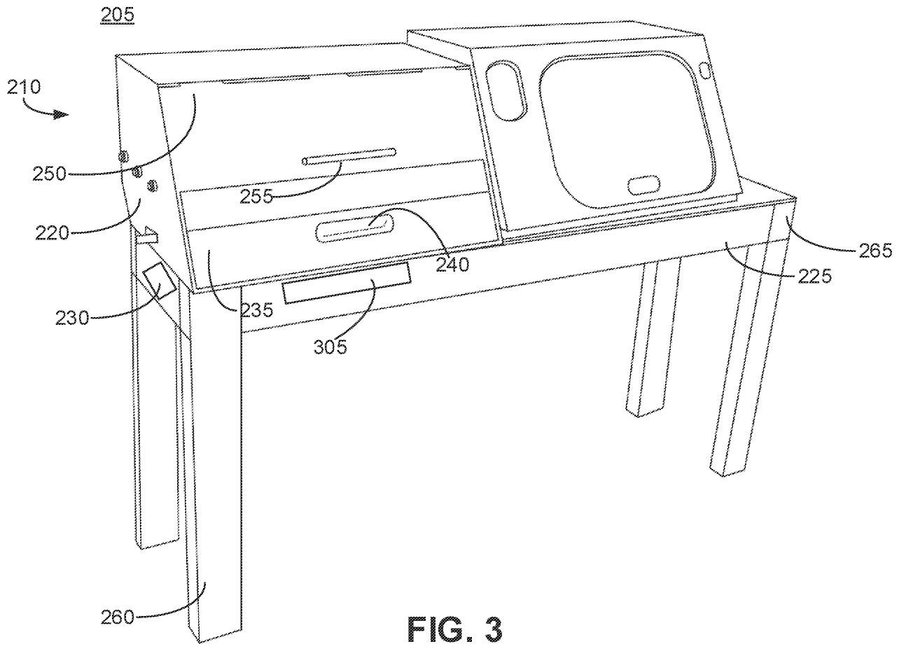

FIG. 3 depicts an example view of the apparatus 205. The apparatus 205 can include at least one lift device 305. The lift device can be mounted, attached, placed, secured or coupled with the grilling module 210. The lift device 305 can lift the grilling module 210 or component thereof from a first height to a second height. The first height and the second height can be associated with at least one stowed position or deployed position of the grilling module 210. The lift device 305 can include at least one of a motor, piston, or hydraulic that can lift the grilling module 210.

FIG. 3 depicts an example of the lid 250 in an covered position (e.g., the cooking surface 215 is covered and insulated by the lid 250), an example of the compartment 235 in a position that is within the grilling module 210, an example of the grilling module 210 in a stowed position and an example of the grilling module 210 at a first height.

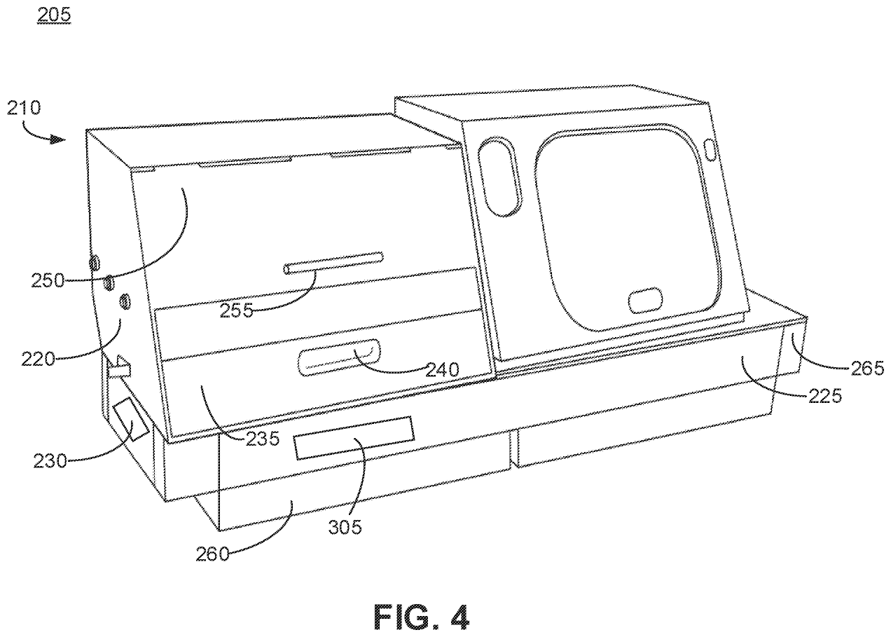

FIG. 4 depicts an example view of the apparatus 205. The apparatus 205 can include the grilling module 210, the shuttle 225, the locking mechanism 230, the compartment 235, the lid 250 and the leg 260. The grilling module 210 can include the housing 220. The compartment 235 can include the handle 240. The lid 250 can include the handle 255. FIG. 4 depicts an example of the lid 250 in a covered position, an example of the compartment 235 in a position that is within the grilling module 210, an example of the grilling module 210 in stowed position and an example of leg 260 in a storage position.

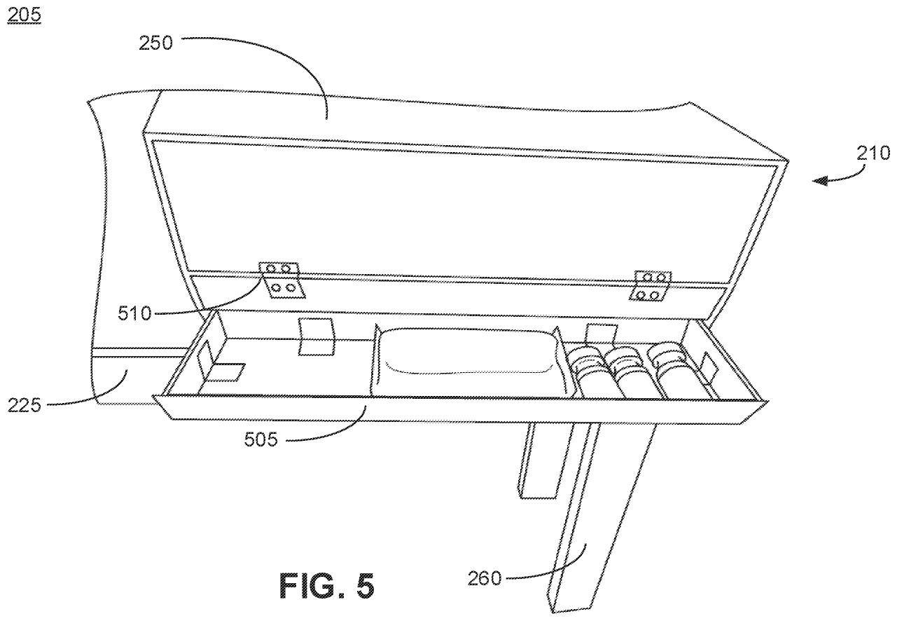

FIG. 5 depicts an example view of the apparatus 205. The apparatus 205 can include at least one hinge 510 and at least one compartment 505. The hinge 510 can be mounted, attached, placed, secured or coupled with the lid 250. The hinge 510 can pivot, spin, rotate or otherwise move to enable the lid 250 to move from a first position to a second position. The compartment 505 can be similar to the compartment 235. For example, the compartment 505 can store components similar to the component 238. FIG. 5 depicts an example of the lid 250 in a covered position, an example of the grilling module 210 in a deployed position, an example of the compartment 505 in a position that is external to the grilling module 210 and an example of the leg 260 in a support position.

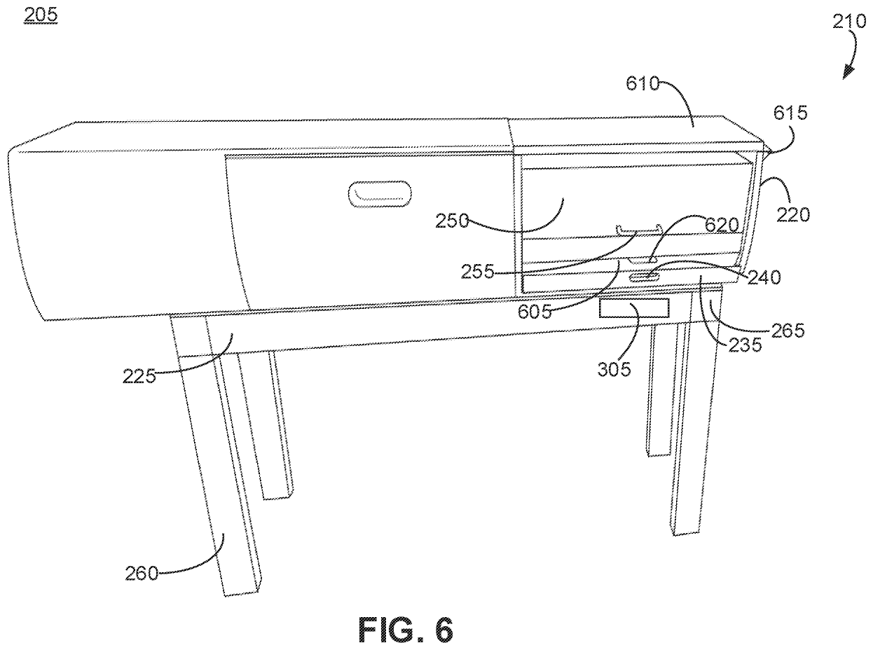

FIG. 6 depicts an example view of the apparatus 205. The apparatus 205 can include at least one compartment 605. The compartment 605 can be similar to the compartment 235. For example, the compartment 605 can have rails that allow for the compartment 605 to extend or retract to a position external the apparatus 205. The compartment can have at least one handle 620. An operator of the apparatus 205 can use the handle 620 to open or close the compartment 605. The compartment 605 can be mounted, attached, placed, secured or coupled with the housing 220. The apparatus 205 can include at least one shelf 610. The shelf 610 can support at least one object (e.g., a stereo, a cooler, a cutting board, a TV). The shelf 610 can include at least one hinge 615. The hinge 615 can be mounted, attached, placed, secured or coupled with the housing 220. The hinge 615 can pivot, spin, rotate or otherwise move to enable the shelf 610 to move from a storage position to a usage position. FIG. 6 depicts an example of the shelf 610 in a storage position, an example of the grilling module 210 in a stowed position, an example of the leg 260 in a support position, an example of the lid 250 in a covered position, an example of the compartment 235 in position that is within the grilling module 210 and an example of the compartment 605 in a position that is within the grilling module 210.

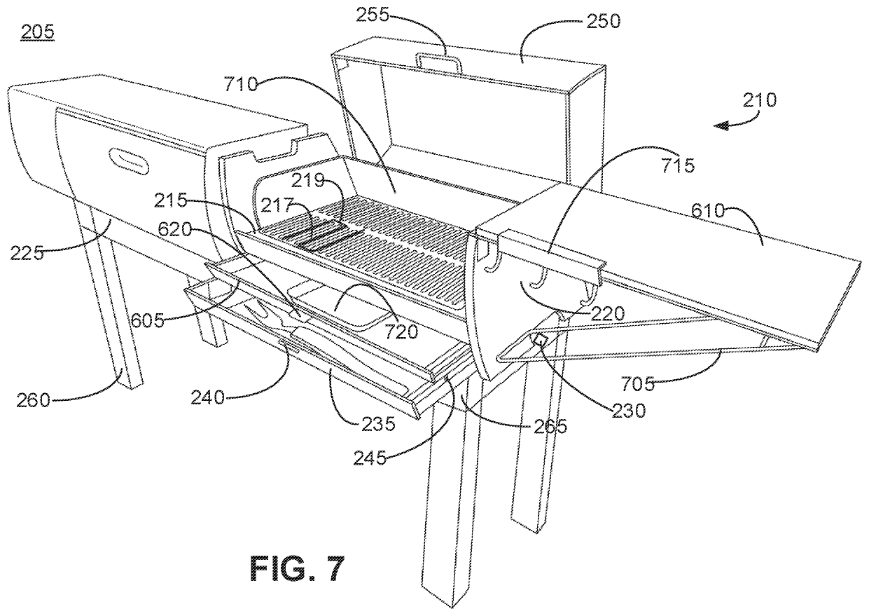

FIG. 7 depicts an example view of the apparatus 205. The apparatus 205 can include at least one support frame 705. The support frame 705 can be mounted, attached, placed, secured or coupled with the housing 220. The support frame 705 can support the shelf 610 when the shelf 610 is in a usage position. The support frame 705 can have at least one support position and at least one storage position. The apparatus 205 can include at least one shield 710. The shield 710 can be mounted, attached, placed, secured or coupled with the cooking surface 215. The shield 710 can protect the cooking surface 215 from wind or debris. The shield 710 can also insulate the cooking surface 215. The apparatus 205 can include at least one removable storage 715. The storage 715 can be mounted, attached, placed, secured or coupled with the shelf 610. The storage 715 can hold at least one component. For example, the storage 715 can hold the component 238.

The compartment 605 can include at least one component 720. For example, the component 720 can be a drip pan. The component 720 can be positioned within the compartment 605 and the component 720 can proximate to the cooking surface 215 in order to collect any excess liquids or matter that may leave the cooking surface 215. For example, the component 720 can collect grease that may leave a piece of food that is on the cooking surface 215. FIG. 7 depicts an example of the lid 250 in an open position, an example of the grilling module 210 in a deployed position, an example of the leg 260 in a support position, an example of the compartment 235 in a position that is external to the grilling module 210, an example of the compartment 605 in a position that is external to the grilling module 210, an example of the shelf 610 in a usage position, an example of the heating element 219 in a zig-zag pattern that goes around the grates 217 and an example of the support frame 705 in a support position.

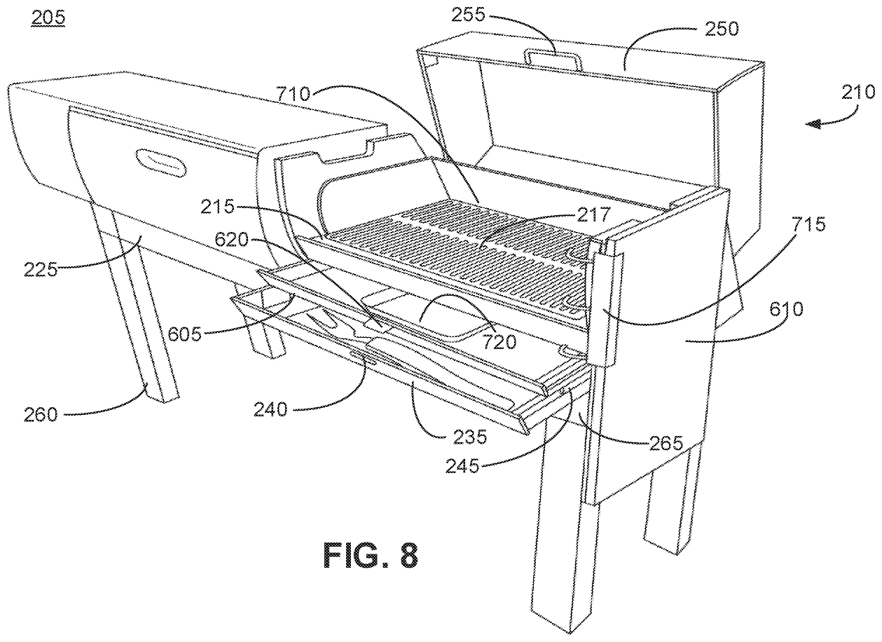

FIG. 8 depicts an example view of the apparatus 205. FIG. 8 depicts an example of the lid 250 in an open position, an example of the grilling module 210 in a deployed position, an example of the leg 260 in a support position, an example of the compartment 235 in a position that is external to the grilling module 210, an example of the compartment 605 in a position that is external to the grilling module 210 and an example of the shelf 610 in a storage position.

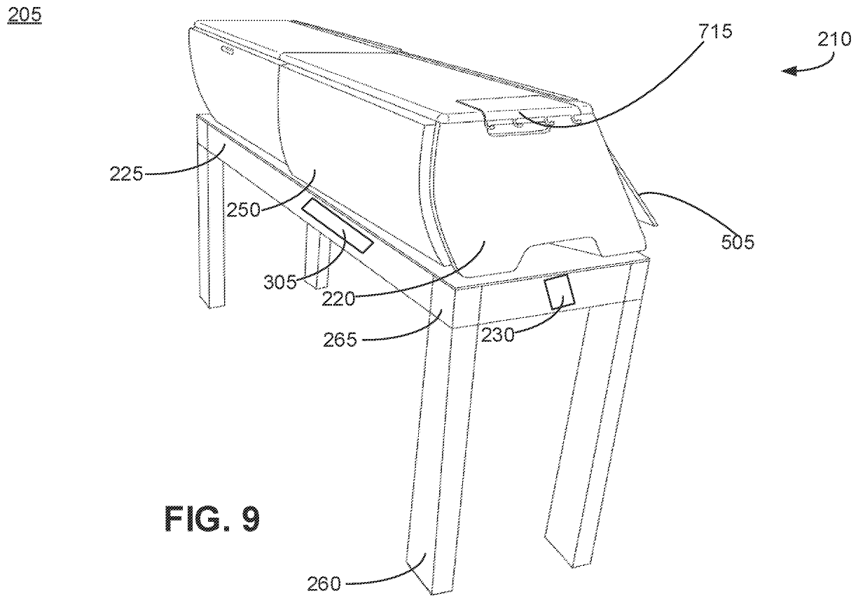

FIG. 9 depicts an example view of the apparatus 205. FIG. 9 depicts an example of the lid 250 in a covered position, an example of the grilling module 210 in a deployed position, an example of the leg 260 in a support position and an example of the compartment 505 in a position that is external to the grilling module 210.

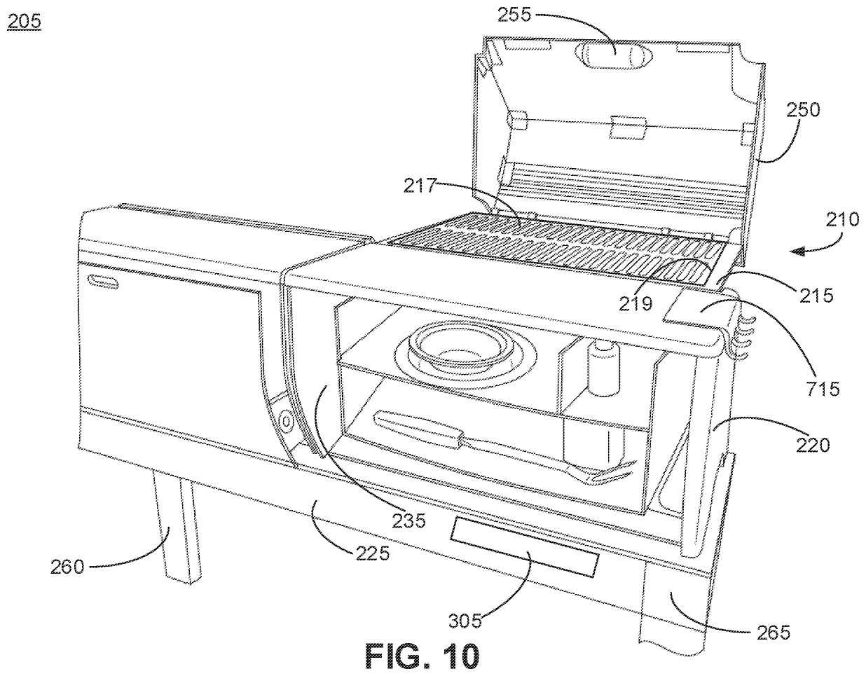

FIG. 10 depicts an example view of the apparatus 205. FIG. 10 depicts an example of the lid 250 in an open position, an example of the grilling module 210 in a deployed position and an example of the leg 260 in a support position.

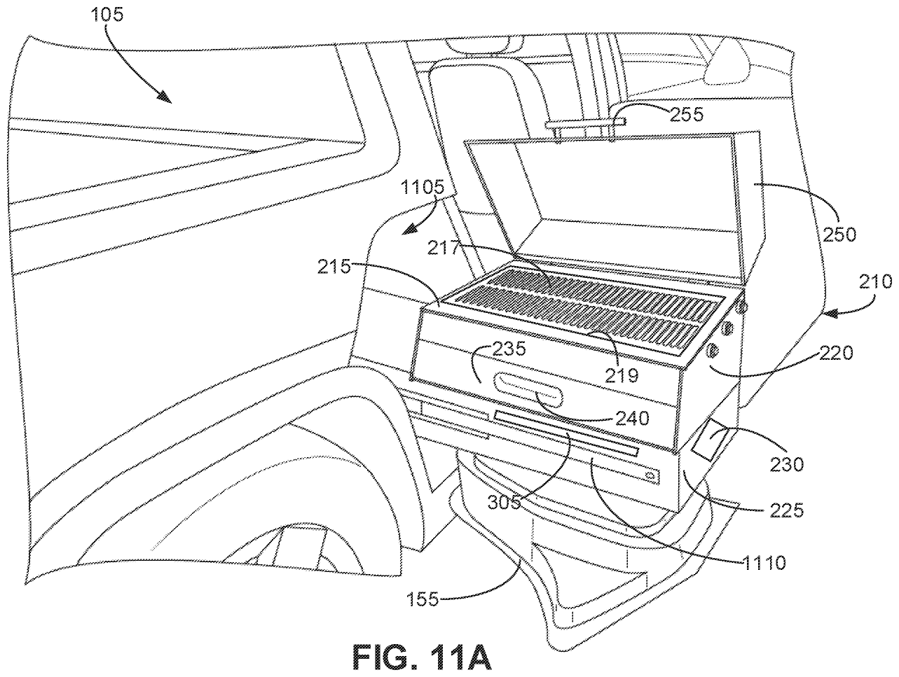

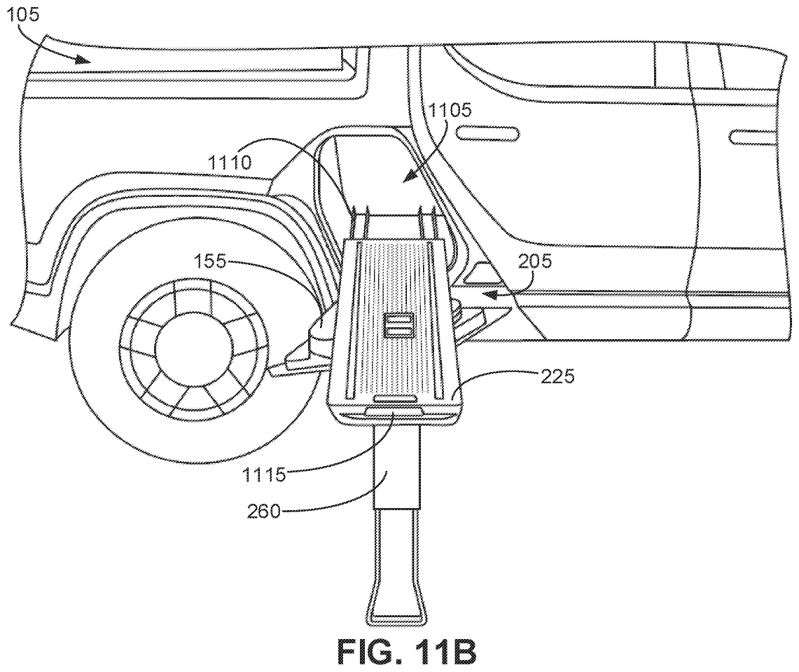

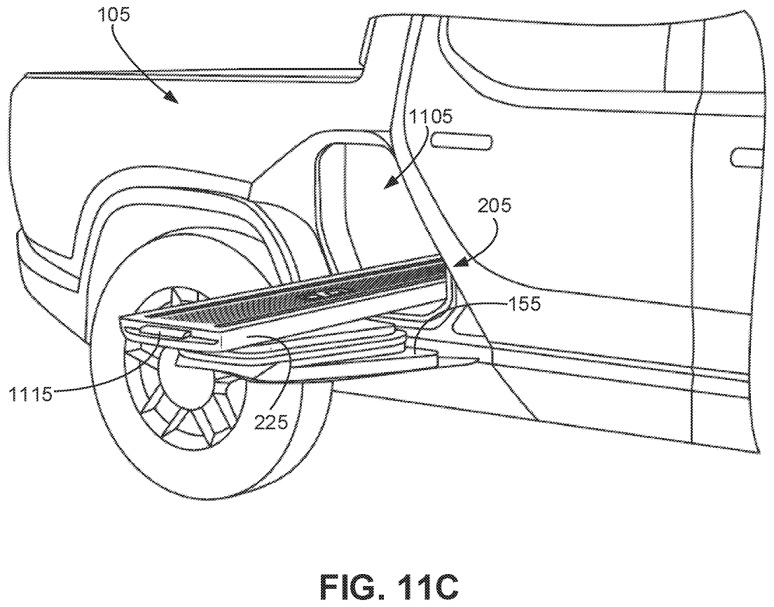

FIG. 11A depicts an example view of the vehicle 105 with the grilling module 210 in a partially deployed position. The apparatus 205 can be mounted, attached, placed, secured or coupled with a gear tunnel 1105. The gear tunnel 1105 can be covered by the gear tunnel door 155. The gear tunnel 1105 can be part of a vehicle. For example, the gear tunnel 1105 can be included within the vehicle 105. The gear tunnel 1105 can store components. The components can be equipment (e.g., an apparatus 205), tools, camping supplies, groceries, toys, beverages, coolers, folding chairs, sports equipment, cooking equipment. The owner or other operator can store equipment in the gear tunnel 1105. For example, the owner can carry equipment to a campsite, to a tailgate event (e.g., a parking lot), to a sporting event, to an event (e.g., a party).

The gear tunnel 1105 can include an opening, compartment, chamber, or other area internal to the vehicle 105 that can store gear such as equipment or accessories for the vehicle or for use by the operator or passenger of the vehicle. The gear tunnel 1105 can include at least one shuttle (e.g., shuttle 225) that extends out from the gear tunnel 1105. The shuttle 225 can ride on tracks and rails that extend or retract. A user can open a gear tunnel door 155 of the electric vehicle 105 and extend the shuttle 225 to access equipment (e.g., the apparatus 205). For example, a user could pull on the shuttle 225 or a motor, piston, or hydraulic of the shuttle 225 to extend the shuttle 225 (e.g., responsive to a user pressing a button). The user can retract the shuttle 225 and close the gear tunnel door 155 to hold the equipment within the electric vehicle 105 when the user is driving. For example, the user can retract the shuttle 225 to a position that is within the gear tunnel 1105 and then can stow the grilling module 210 in a position that is within the gear tunnel 1105.

The gear tunnel 1105 can extend across the electric vehicle 105. The gear tunnel 1105 can include at least one top portion, at least one bottom portion, at least one first side portion, and at least one second side portion. The first side portion can extend up from a bottom portion to a top portion at an oblique angle to the bottom portion. The first side portion and the second side portion can be parallel (e.g., parallel and oblique to the bottom portion or parallel and perpendicular to the bottom portion). The first side portion and the second side portion can be slanted towards each other or away from each other. The first side portion can include an oblique sub-portion that extends from a bottom of the gear tunnel 1105 and a perpendicular sub-portion that extends up to the top portion of the gear tunnel 1105 from an end of the oblique sub-portion.

The gear tunnel 1105 can be disposed adjacent a cargo bed of the electric vehicle 105. The gear tunnel 1105 can be disposed adjacent a rear passenger storage area. The gear tunnel 1105 can be disposed between the cargo bed and the rear passenger storage area. The gear tunnel 1105 can include a bottom portion (e.g., the shuttle 225) that extends out from the gear tunnel 1105. The shuttle 225 can be supported by the vehicle 105. The shuttle 225 can include at least one leg 260 that rests on the ground and supports the bottom portion. The shuttle 225 can extend out of, or retract into, the gear tunnel 1105. At least one rail 1110 can extend the shuttle 225 out of the gear tunnel 1105. The rail 1110 can stow or deploy the shuttle 225. The rail 1110 that the shuttle 225 extends on can be mounted to a frame that sits inside the gear tunnel 1105. The shuttle 225 can have at least one stowed position and at least one deployed position. The stowed position can be a position that is within the vehicle 105. The stowed position can be a position that is within the gear tunnel 1105 of the vehicle 105. The stowed position of the shuttle 225 can be the same stowed position as the grilling module 210, for example the shuttle 225 and the grilling module 210 can both be stowed in a position that is within the gear tunnel 1105 of the vehicle 105. The deployed position can be a position that is external to vehicle 105. The deployed position can be a position that is external to the gear tunnel 1105 of the vehicle 105. The deployed position of the shuttle 225 can be the same deployed position as the grilling module 210.

FIG. 11A depicts an example of the gear tunnel door 155 in an open position, an example of the grilling module 210 in a deployed position that is external to the gear tunnel 1105 of the vehicle 105, an example of the lid 250 in an open position, an example of the compartment 235 in a position that is within the grilling module 210 and an example of the shuttle 225 in a deployed position that is external to the gear tunnel 1105 of the vehicle 105.

FIG. 11B depicts an example view of the apparatus 205. The shuttle 225 can include at least one handle 1115. An operator of the apparatus 205 can use the handle 1115 to stow or deploy the apparatus 205. For example, an operator can use the handle 1115 to stow the apparatus 205 in a position that is within the gear tunnel 1105 of the vehicle 105. The operator can use the handle 1115 to deploy the apparatus 205 to a position that is external to the gear tunnel 1105 of the vehicle 105.

FIG. 11B depicts an example of the gear tunnel door 155 in an open position, an example of the apparatus 205 in a deployed position that is external to the gear tunnel 1105 of the vehicle 105, an example of the shuttle 225 in a deployed position that is external to the gear tunnel 1105 of the vehicle 105 and an example of the leg 260 in a support position.

FIG. 11C depicts an example view of the apparatus 205. FIG. 11C depicts an example of the gear tunnel door 155 in an open position, an example of the apparatus 205 in a deployed position that is external to the gear tunnel 1105 of the vehicle 105 and an example of the shuttle 225 in a deployed position that is external to the gear tunnel 1105 of the vehicle 105.

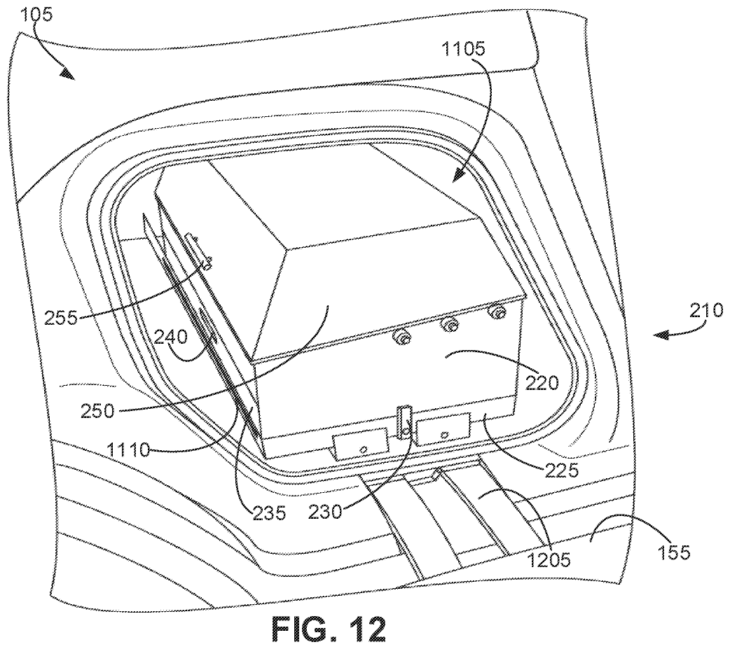

FIG. 12 depicts an example view of the apparatus 205. The apparatus 205 can be stowed within the gear tunnel 1105. The grilling module 210 can be stowed within the gear tunnel 1105. The gear tunnel door 155 can include at least one hinge 1205. The hinge 1205 can pivot, spin, rotate or otherwise move to enable the gear tunnel door 155 to open and close. FIG. 12 depicts an example of the lid 250 in a covered position, an example of the compartment 235 in a position that is within the grilling module 210, an example of the grilling module 210 in a stowed position that is within the gear tunnel 1105, an example of the shuttle 225 in a stowed position that is within the gear tunnel 1105 and an example of the gear tunnel door 155 in an open position.

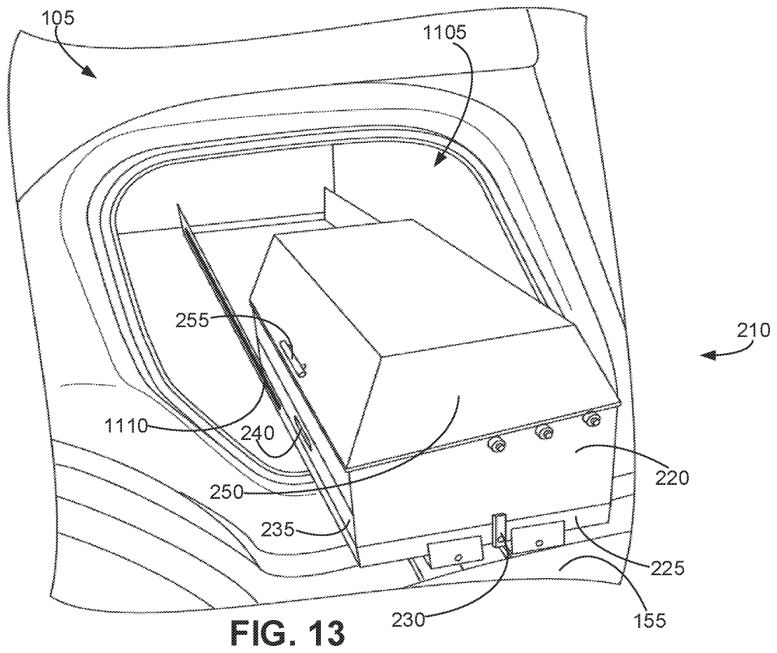

FIG. 13 depicts an example apparatus 205. The apparatus 205 can be moving from a stowed position within the gear tunnel 1105 to a deployed position external to the gear tunnel 1105 or can be moving from a deployed position to a stowed position within the gear tunnel 1105. FIG. 13 depicts an example of the lid 250 in a covered position, an example of the compartment 235 in a position that is within the grilling module 210, an example of the grilling module 210 in a stowed position, an example of the shuttle 225 in a deployed position and an example of the gear tunnel door 155 in an open position.

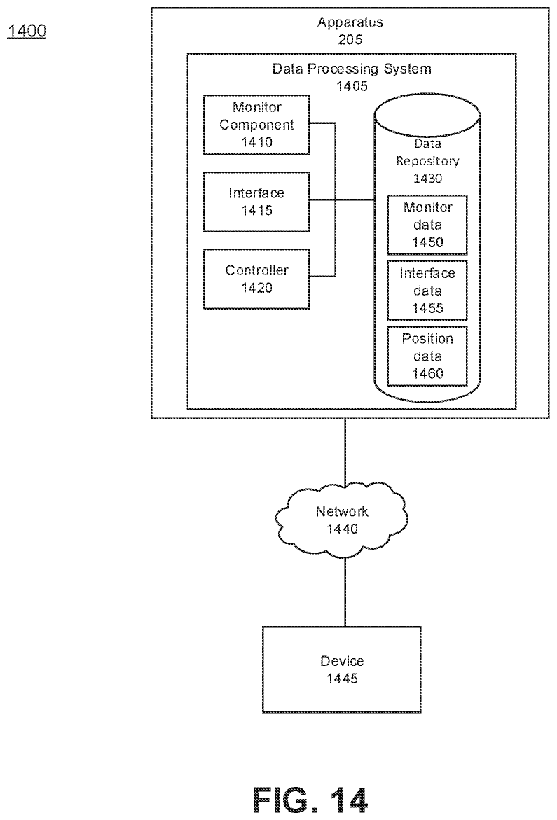

FIG. 14 depicts an example system 1400 to control an apparatus, in accordance with an implementation. The system 1400 can include the apparatus 205. The apparatus 205 can include a data processing system 1405. The data processing system 1405 can include a monitor component 1410, an interface 1415 and a controller 1420. The monitor component 1410 can include at least one sensor. The sensors can collect data. The sensors can include at least one of a temperature sensor, a battery cell sensor, a location sensor, a motion sensor, an interface sensor or a user sensor. The monitor component 1410 can include, communicate with or otherwise interface with a temperature sensor. The temperature sensor can collect data that can be used to determine a temperature of at least one of the apparatus 205, the grilling module 210, the cooking surface 215 or the heating element 219. For example, the temperature sensor can be placed proximate to the cooking surface 215 and can detect, sense or measure a temperature of the cooking surface 215 or the heating element 219. The monitor component 1410 can compare the temperature of the heating element 219 to a predetermined temperature metric. The monitor component 1410 can determine at least one of that the temperature of the heating element 219 is smaller than the predetermined temperature metric, that the temperature of the heating element 219 is larger than the predetermined temperature metric or that the temperature of the heating element 219 is equal to the predetermined temperature metric. The monitor component 1410, responsive to determining that the temperature of the heating element 219 is larger than the predetermined temperature metric, can communicate, interact or otherwise interface with the controller 1420. The monitor component 1410 can provide an indication, to the controller 1420, that the temperature of the heating element 219 is larger than the predetermined temperature metric. The controller 1420 can, responsive to receiving the indication, prevent power from being provided to at least one of the grilling module 210, the cooking surface 215 or the heating element 219.

The monitor component 1410 can include, communicate with or otherwise interface with a battery cell sensor. The battery cell sensor can collect data that can be used to determine the state of charge (SoC) of the battery, the state of health (SoH) of the battery or energy consumption. For example, the battery cell sensor can include a voltage sensor or current sensor. The battery cell sensor can be used to determine a voltage. The monitor component 1410 can determine the SoC of a battery based on monitoring voltage, amperage, or ampere hours remaining of the battery. For example, the monitor component 1410 can determine the voltage or current output of the battery and compare the measurements with a predetermined graph for the battery to determine a state of charge of the battery. In some cases, the monitor component 1410 can determine the state of charge of the battery as a percentage that is a function of the terminal voltage of the battery. The monitor component 1410 can compare the SoC of the battery with a predetermined SoC metric. The monitor component 1410 can determine at least one of that the SoC of the battery is larger than the predetermined SoC metric, that the SoC of the battery is smaller than the predetermined SoC metric or that the SoC of the battery is equal to the predetermined SoC metric. The monitor component 1410, responsive to determining that the SoC of the battery is smaller than the predetermined SoC metric, can communicate, interact or otherwise interface with the controller 1420. The monitor component 1410 can provide an indication, to the controller 1420, that the SoC of the battery is smaller than the predetermined SoC metric. The controller 1420 can, responsive to receiving the indication, prevent power from being provided to at least one of the grilling module 210, the cooking surface 215 or the heating element 219.

The monitor component 1410 can include, communicate with or otherwise interface with a location sensor. The location sensor can collect data that can be used to determine a location or a position of at least one of the apparatus 205, the grilling module 210, the cooking surface 215 or the shuttle 225. The monitor component 1410 can include, communicate with or otherwise interface with a motion sensor. The motion sensor can collect data that can be used to detect motion of at least one of the apparatus 205, the grilling module 210, the cooking surface 215 or the shuttle 225.

The monitor component 1410 can include, communicate with or otherwise interface with an interface sensor. The interface sensor can collect data that can be used to determine a selection on an interface. For example, the interface sensor can be a tactile sensor. The interface sensor can detect an operator of the apparatus 205 selecting at least one option presented on a user interface (e.g., interface 1415). For example, an operator can select on option to stow the grilling module 210.

An operator of the apparatus 205, using the interface 1415, can perform one or more operations of the apparatus 205. For example, an operator can select an icon displayed by the interface 1415 to deploy the grilling module 210 to a position that is external to the gear tunnel 1105. Similarly, the operator can select an icon displayed by the interface 1415 to stow the grilling module 210. The interface 1415, responsive to the operator selecting the icon to stow or deploy the grilling module 210, can then interact with the controller 1420. The controller 1420, responsive to interacting with the interface 1415 can either stow or deploy the grilling module 210. The controller 1420 can include at least one of a motor, a piston, or hydraulic. The controller 1420 can be mounted, attached, placed, secured or coupled with the shuttle 225. The controller 1420 can be mounted, attached, placed, secured or coupled with the lift device. The motor can deploy or stow both the shuttle 225 and the grilling module 210. The controller 1420 can also control the heating element 219 of the apparatus 205. The controller 1420 can also control the locking mechanism 230.

The data processing system 1405 and a user device 1445 can interact by using a network 1440. The user device 1445 can include at least one of a mobile phone, a smart watch, a tablet, a smart phone, an infotainment system of a vehicle (e.g., the infotainment system of the vehicle 105). An operator of the user device 1445 can perform similar operations to that performed by selecting icons on the interface 1415. For example, the user device 1445 can include an application that has been stored on the user device 1445 and is associated with the apparatus 205. For example, when an operator purchased the apparatus 205 they received instructions of how to download the application and link the application with the apparatus 205. An operator of the user device 1445 can select an icon on an interface of the user device 1445 to either stow or deploy the grilling module 210 in a position that it is either within or external the gear tunnel 1105.

The data processing system 1405 includes a data repository 1430. The data repository 1430 can include, store, maintain or otherwise provide data. The data can be data that is collected and provided by the monitor component 1410, data that is collected and provided by the interface 1415 or data that is provided by the user device 1445. The data this is provided by the monitor component 1410 can be provided as monitor data 1450. The data that is provided by the interface 1415 can be provided as interface data 1455. The data that is provided by the user device 1445 can be provided as the interface data 1455. The data repository 1430 can include at least one predetermined range of positions of the cooking surface 215. The predetermined range can include at least one cooking position. The predetermined range can be provided as position data 1460.

The monitor component 1410 can detect a position of the cooking surface 215. The monitor component 1410 can retrieve, from the data repository 1430, the position data 1460. The monitor component 1410 can compare the detected position of the cooking surface 215 with the predetermined range. The monitor component 1410 can determine that the detected position of the cooking surface 215 is within the predetermined range. The monitor component 1410, responsive to determining that the cooking surface 215 is within the predetermined range, can interact with the interface 1415 and provide an indication that the detected position of the cooking surface 215 is within the predetermined range. The interface 1415, responsive to receiving the indication from the monitor component 1410, can present an indication, to the operator of the apparatus 205, that the cooking surface 215 is within the predetermined range.

The monitor component 1410 can detect a second position of the cooking surface 215. The monitor component 1410 can retrieve, from the data repository 1430, the position data 1460. The monitor component 1410 can compare the detected position of the cooking surface 215 with the predetermined range. The monitor component 1410 can determine that the cooking surface 215 is not within the predetermined range. The monitor component 1410, responsive to determining that the cooking surface 215 is not within the predetermined range, can interact with the controller 1420 and provide, to the controller 1420, an indication that the second detected position of the cooking surface 215 is not within the predetermined range. The controller 1420, responsive to receiving the indication from the monitor component 1410, can prevent power from being provided to the cooking surface 215. The monitor component 1410, responsive to determining that the cooking surface 215 is not within the predetermined range, can interact with the interface 1415 and provide, to the interface 1415, the indication that the second detected position of the cooking surface is not within the predetermined range. The interface 1415, responsive to receiving the indication, can present a notice, to the operator of the apparatus 205, that the cooking surface 215 is not within the predetermined range.

The data processing system 1405 can receive a first indication from an operator of either the apparatus 205 or the user device 1445. The indication can be an indication to stow the grilling module 210 in a position that is within the gear tunnel 1105 of the vehicle 105. The controller 1420 can control the shuttle 225 to stow the grilling module 210 in a position that is within the gear tunnel 1105 of the vehicle 105. The data processing system 1405 can receive a second indication from an operator or either the apparatus 205 or the user device 1445. The second indication can be an indication to deploy the grilling module 210 to a position that is external to the gear tunnel 1105 of the vehicle 105. The controller 1420 can control the shuttle 225 to deploy the grilling module 210 to a position that is external to the gear tunnel 1105 of the vehicle 105.

The data processing system 1405 can receive an indication from an operator of either the apparatus 205 or the user device 1445. The indication can be an indication to adjust the temperature of the cooking surface 215. The controller 1420 can control the heating element 219 to adjust the temperature of the cooking surface 215.

The data processing system 1405 can receive an indication from an operator of either the apparatus 205 or the user device 1445. The indication can be an indication to adjust the height of the grilling module 210. The controller 1420 can control the lift device to adjust the height of the grilling module 210.

The data processing system 1405 can receive an indication from an operator of either the apparatus 205 or the user device 1445. The indication can be an indication to open the locking mechanism 230. The controller 1420 can control the locking mechanism 230 in order to open the locking mechanism 230.

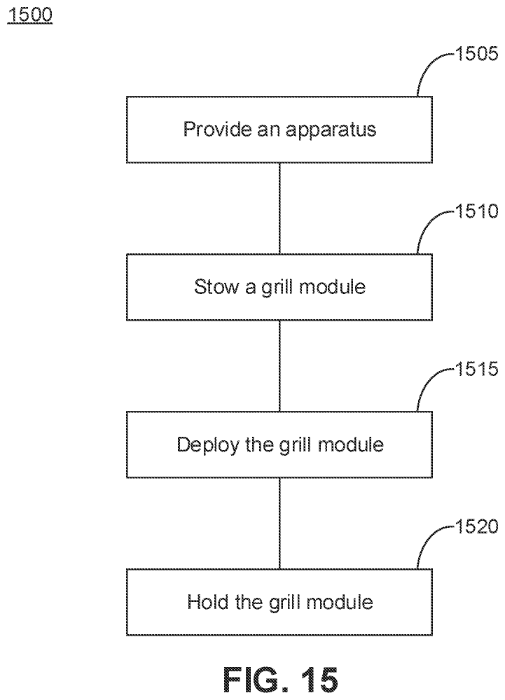

FIG. 15 is a flow diagram of a process 1500 where an apparatus can be provided. One or more acts of the process 1500 can be performed by one or more components depicted in FIG. 14, including, for example, the data processing system 1405. In ACT 1505, an apparatus can be provided. For example, the apparatus can be the apparatus 205. The apparatus 205 can be provided to a vehicle (e.g., the vehicle 105). The apparatus 205 can be provided during the manufacturing process of the vehicle 105. The apparatus 205 can be provided after the vehicle 105 has been purchased. For example, the apparatus 205 can be provided after the owner of the vehicle 105 purchases the apparatus 205 and the owner then takes the vehicle 105 to a shop that can then provide the apparatus 205. The owner of the vehicle 105 can provide the apparatus 205 on their own. For example, the owner of the vehicle 105 can provide the apparatus 205 upon purchasing the apparatus 205. The apparatus 205 can include a grilling module (e.g., the grilling module 210), a shuttle (e.g., the shuttle 225) and a locking mechanism (e.g., the locking mechanism 230). The grilling module 210 can include the cooking surface 215 and the housing 220.

In ACT 1510, a grilling module can be stowed. For example, the grilling module can be the grilling module 210. The grilling module 210 can be stowed in a position that is within the gear tunnel of a vehicle (e.g., the gear tunnel 1105 of the vehicle 105). The grilling module 210 can be stowed during the manufacturing process of the vehicle 105. The grilling module 210 can be stowed after the vehicle 105 has been purchased. For example, an operator could pull on the shuttle 225 or a motor, piston, or hydraulic of the shuttle 225 to stow the grilling module 210 (e.g., responsive to a user pressing a button). The operator can stow the grilling module 210 by interacting with the data processing system 1405. The operator can select an icon on the interface 1415 to stow the grilling module 210. The operator can use the user device 1445 to provide an indication, to stow the grilling module 210, to the data processing system 1405. The data processing system 1405, responsive to the operator interacting with the interface 1415 or responsive to receiving the indication to stow the grilling module 210, can stow the grilling module 210.

In ACT 1515, the grilling module 210 can be deployed. The grilling module 210 can be deployed to a position that is external to the gear tunnel of a vehicle (e.g., the gear tunnel 1105 of the vehicle 105). The grilling module 210 can be deployed during the manufacturing process of the vehicle 105. The grilling module 210 can be deployed after the vehicle has been purchased. For example, an operator could pull on the shuttle 225 or a motor, piston, or hydraulic of the shuttle 225 to deploy the grilling module 210 (e.g., responsive to a user pressing a button). The operator can deploy the grilling module 210 by interacting with the data processing system 1405.

The operator can select an icon on the interface 1415 to deploy the grilling module 210. The operator can use the user device 1445 to provide an indication, to deploy the grilling module 210, to the data processing system 1405. The data processing system 1405, responsive to the operator interacting with the interface 1415 or responsive to receiving the indication to deploy the grilling module 210, can deploy the grilling module 210.

In ACT 1520, the grilling module 210 can be held. For example, the grilling module 210 can be held in at least one of the stowed position or the deployed position. An operator can use the locking mechanism 230 to hold the grilling module 210 in the stowed position or the deployed position. The operator can hold the grilling module 210 by interacting with the data processing system 1405. The operator can select an icon on the interface 1415 to hold the grilling module 210. The operator can use the user device 1445 to provide an indication, to hold the grilling module 210, to the data processing system 1405. The data processing system 1405, responsive to the operator interacting with the interface 1415 or responsive to receiving the indication to hold the grilling module 210, can hold the grilling module 210.

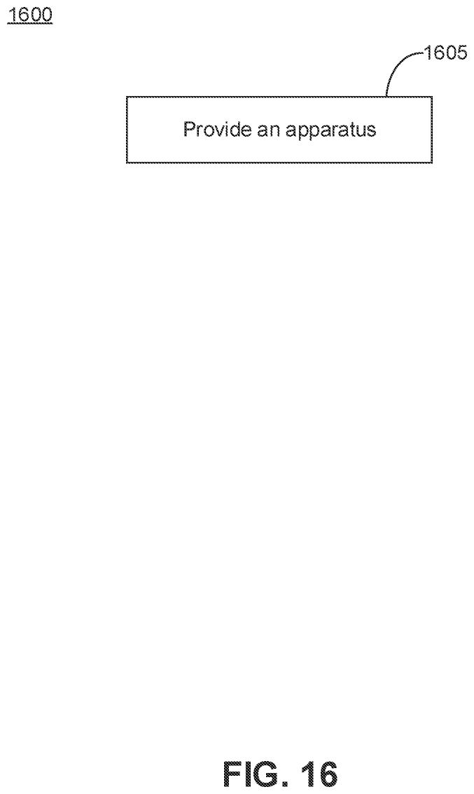

FIG. 16 is a flow diagram of a process 1600 where an apparatus can be provided. One or more acts of the process 1600 can be performed by one or more components depicted in FIG. 14, including, for example, the data processing system 1405. In ACT 1605, an apparatus can be provided. For example, the apparatus can be the apparatus 205. The apparatus 205 can be provided to a vehicle (e.g., the vehicle 105). The apparatus 205 can be provided during the manufacturing process of the vehicle 105. The apparatus 205 can be provided after the vehicle 105 has been purchased. For example, the apparatus 205 can be provided after the owner of the vehicle 105 purchases the apparatus 205 and the owner then takes the vehicle 105 to a shop that can then provide the apparatus 205. The owner of the vehicle 105 can provide the apparatus 205 on their own. For example, the owner of the vehicle 105 can provide the apparatus 205 upon purchasing the apparatus 205. The apparatus 205 can include a grilling module (e.g., the grilling module 210), a shuttle (e.g., the shuttle 225) and a locking mechanism (e.g., the locking mechanism 230). The grilling module 210 can include the cooking surface 215 and the housing 220.

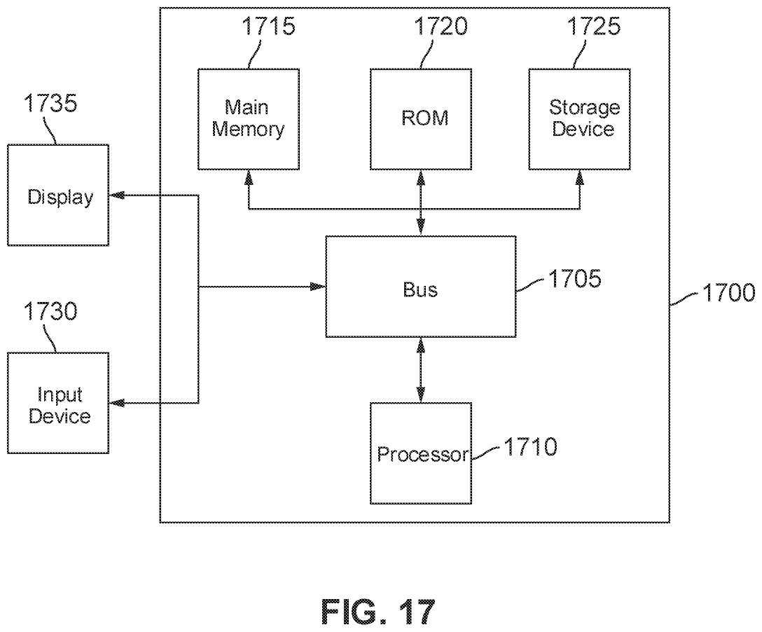

FIG. 17 depicts an example block diagram of an example computer system 1700. The computer system or computing device 1700 can include or be used to implement a data processing system or its components. The computing system 1700 includes at least one bus 1705 or other communication component for communicating information and at least one processor 1710 or processing circuit coupled to the bus 1705 for processing information. The computing system 1700 can also include one or more processors 1710 or processing circuits coupled to the bus for processing information. The computing system 1700 also includes at least one main memory 1715, such as a random access memory (RAM) or other dynamic storage device, coupled to the bus 1705 for storing information, and instructions to be executed by the processor 1710. The main memory 1715 can be used for storing information during execution of instructions by the processor 1710. The computing system 1700 may further include at least one read only memory (ROM) 1720 or other static storage device coupled to the bus 1705 for storing static information and instructions for the processor 1710. A storage device 1725, such as a solid state device, magnetic disk or optical disk, can be coupled to the bus 1705 to persistently store information and instructions.

The computing system 1700 may be coupled via the bus 1705 to a display 1735, such as a liquid crystal display, or active matrix display, for displaying information to a user such as a driver of the electric vehicle 105 or other end user. An input device 1730, such as a keyboard or voice interface may be coupled to the bus 1705 for communicating information and commands to the processor 1710. The input device 1730 can include a touch screen display 1735. The input device 1730 can also include a cursor control, such as a mouse, a trackball, or cursor direction keys, for communicating direction information and command selections to the processor 1710 and for controlling cursor movement on the display 1735.

The processes, systems and methods described herein can be implemented by the computing system 1700 in response to the processor 1710 executing an arrangement of instructions contained in main memory 1715. Such instructions can be read into main memory 1715 from another computer-readable medium, such as the storage device 1725. Execution of the arrangement of instructions contained in main memory 1715 causes the computing system 1700 to perform the illustrative processes described herein. One or more processors in a multi-processing arrangement may also be employed to execute the instructions contained in main memory 1715.

Hard-wired circuitry can be used in place of or in combination with software instructions together with the systems and methods described herein. Systems and methods described herein are not limited to any specific combination of hardware circuitry and software.

Although an example computing system has been described in FIG. 17, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a grilling module having a cooking surface electrically coupled with a power source; and
the grilling module coupled with a shuttle configured to stow the grilling module and deploy the grilling module.

2. The apparatus of claim 1, comprising:
a heating element configured to heat the cooking surface;
a locking mechanism configured to lock the grilling module;
a compartment configured to store one or more components;
a lid configured to cover the cooking surface;
at least one rail, coupled with the shuttle, to:
stow the shuttle in a first position within a gear tunnel of a vehicle; and
deploy the shuttle to a second position external to the gear tunnel of the vehicle; and
at least one leg, coupled with the shuttle, to support the shuttle in the second position.

3. The apparatus of claim 1, comprising:
a data processing system, the data processing system comprising at least one processor, coupled with memory, to:
detect a position of the cooking surface;
compare the position of the cooking surface to a predetermined range, wherein the predetermined range indicates one or more cooking positions;
determine that the position of the cooking surface is within the predetermined range; and
present, by a graphical user interface, an indication that the cooking surface is within the predetermined range.

4. The apparatus of claim 3, comprising:
the data processing system to:
prevent, responsive to the cooking surface being outside of the predetermined ranged, current from being provided to the cooking surface; and
present, via the graphical user interface, a notice that the cooking surface is outside of the predetermined range.

5. The apparatus of claim 1, comprising:
a data processing system, the data processing system comprising at least one processor, coupled with memory, to:
receive, via a graphical user interface, a first indication to stow the grilling module in a first position;
stow, responsive to the first indication, the grilling module in the first position;
receive, via the graphical user interface, a second indication to deploy the grilling module to a second position; and
deploy, responsive to the second indication, the grilling module to the second position.

6. The apparatus of claim 1, comprising:
a data processing system, the data processing system comprising at least one processor, coupled with memory, to:
receive, via a graphical user interface, an indication to adjust a temperature of the cooking surface; and
adjust, responsive to the indication, the temperature of the cooking surface.

7. The apparatus of claim 1, wherein the power source is a battery of an electric vehicle.

8. The apparatus of claim 1, wherein the grilling module is stowed in a first position within a gear tunnel of a vehicle and the grilling module is deployed to a second position external to the gear tunnel of the vehicle.

9. The apparatus of claim 1, wherein the cooking surface includes at least one of an electric cooking surface, a coil cooking surface, and a cast iron cooking surface.

10. The apparatus of claim 1, comprising:
a rotation device, coupled with the grilling module, to rotate the grilling module from a first position to a second position, wherein the first position and the second position are different by at least 90 degrees.

11. The apparatus of claim 1, comprising:
the power source coupled with the grilling module in a first position and a second position.

12. The apparatus of claim 1, comprising:
a lift device, coupled with the grilling module, to:
lift the grilling module from a first height to a second height.

13. A method, comprising:
providing an apparatus, the apparatus comprising:
a grilling module having a cooking surface electrically coupled with a power source;
the grilling module coupled with a shuttle;
stowing, by the shuttle, the grilling module; and
deploying, by the shuttle, the grilling module.

14. The method of claim 13, comprising:
heating, by a heating element, the cooking surface;
locking, by a locking mechanism, the grilling module;
storing, by a compartment, one or more components;
covering, by a lid, the cooking surface;
stowing, by at least one rail, the shuttle in a first position within a gear tunnel of a vehicle;
deploying, by the rail, the shuttle to a second position external to the gear tunnel of the vehicle; and
supporting, by at least one leg, the shuttle in the second position.

15. The method of claim 13, comprising:
detecting, by a processing circuit, a position of the cooking surface;
comparing, by the processing circuit, the position of the cooking surface to a predetermined range, wherein the predetermined range indicates one or more cooking positions;
determining, by the processing circuit, that the position of the cooking surface is within the predetermined range; and
presenting, by a graphical user interface, an indication that the cooking surface is within the predetermined range.

16. The method of claim 13, wherein the power source is a battery of an electric vehicle.

17. The method of claim 13, wherein the grilling module is stowed in a first position within a gear tunnel of a vehicle and the grilling module is deployed to a second position external to the gear tunnel of the vehicle.

18. The method of claim 13, comprising:
rotating, by a rotation device, the grilling module from a first position to a second position, wherein the first position and the second position are different by at least 90 degrees.

19. An electric vehicle, comprising:
a gear tunnel;
an apparatus comprising:
a grilling module having a cooking surface electrically coupled with a battery; and
the grilling module coupled with a shuttle configured to stow the grilling module and deploy the grilling module.

20. The electric vehicle of claim 19, the apparatus comprising:
a heating element configured to heat the cooking surface;
a locking mechanism configured to lock the grilling module;
a compartment configured to store one or more components;
a lid configured to cover the cooking surface;
at least one rail, coupled with the shuttle, to:
stow the shuttle in a first position within the gear tunnel; and
deploy the shuttle to a second position external to the gear tunnel; and
at least one leg, coupled with the shuttle, to support the shuttle in the second position.
